(19) United States
(12) Patent Application Publication
(10) Pub. No.: US 2002/0186858 A1
(43) Pub. Date: Dec. 12, 2002

(54) Loopdown and looparound headsets

(76) Inventors: Masahisa Masuda, Westlinn, OR (US); Donald R. White, Beaverton, OR (US)

Correspondence Address: MARGER JOHNSON & McCOLLOM, P.C., 1030 S.W. Morrison Street, Portland, OR, 97205, US

(21) Appl. No.: 09/878,151

(22) Filed: Jun. 7, 2001

(51) Int. Cl. H04R 25/00

(52) U.S. Cl. 381/380; 381/151; 381/374

(57) ABSTRACT

A headset includes earpieces for attaching to ears of an operator. A band has opposite ends that connect to the two earpieces and extends in a forward direction from the two earpieces. The band then either extends downwardly below the chin or extend backwards in back of the neck. In one implementation, the headset is used for two-way communications with one earpiece containing a microphone and the other earpiece containing a speaker.

### BACKGROUND

Headsets used for listening to music include either earphones that attach over the ears or earpieces that insert into the ears. A band usually made of metal or rigid plastic is attached at opposite ends to the earphones or earpieces. The band of the headset rests on top of the users head supporting the earphones or earpieces against or in the ears. The band on the headset can mess up the hair of the headset operator. The headset is also difficult to attach and detach if the headset operator is wearing a hat. Instead of using a plastic or metal band, some headsets use wires that hang loosely down from the earpieces. However, the earpieces in these headsets can easily dislodge from the user's ears.

Some headsets are used for two-way communication and include a microphone boom that extends over the mouth of the user. The microphone is located on the boom in order to pick up the voice signals generated from the mouth of the user. Because the microphone also picks up ambient noise, it is difficult to use these telephone headsets in noisy environments. Two way headsets also use metal of plastic bands to support the boom and speaker earpiece. These headsets can easily be dislodged when the user is moving and also mess up the hair or disrupt headwear on the operator.

The present invention addresses this and other problems associated with the prior art.

### SUMMARY OF THE INVENTION

A headset includes earpieces for attaching to ears of an operator. A band has opposite ends that connect to the two earpieces and extends in a forward direction from the two earpieces. The band then either extends downwardly below the chin or extend backwards in back of the neck. In one implementation, the headset is used for two-way communications with one earpiece containing a microphone and the other earpiece containing a speaker.

### BRIEF DESCRIPTION OF THE DRAWINGS

FIG. 1 is a front view of a loop down headset.

FIG. 2 is a side view of the loop down headset shown in FIG. 1.

FIG. 3 is a perspective view of the loop down headset.

FIG. 4 is a front view of the loop down headset.

FIG. 5 is a perspective view of a loop back headset.

FIG. 6 is a top view of the loop back headset shown in FIG. 5.

FIG. 7 is a side view of the loop back headset.

FIG. 8 is a schematic diagram of a full duplex circuit that can be used in either the loop down headset shown in FIG. 1 or the loopback headset shown in FIG. 5.

### DETAILED DESCRIPTION

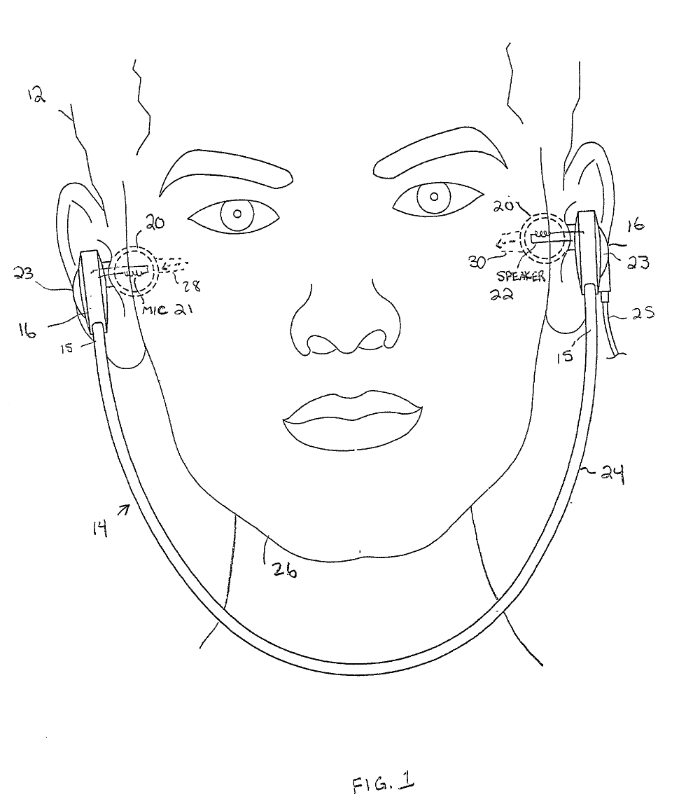

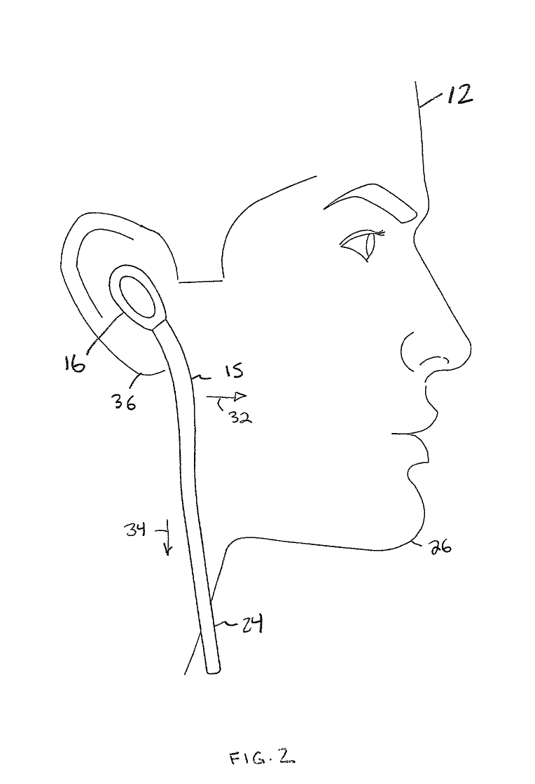

FIGS. 1 and 2 show a loopdown headset 14 that includes two earpieces 16 for attaching to ears of an operator 12. A band 24 has opposite ends 15 that connect to the two earpieces 16. Earpieces 16 include ear cups 20 that insert into ear canals 28 and 30. A middle section of the band 24 extends downwardly below a chin 26 of a headset operator 12. The band 24 in one embodiment is made of a semi-rigid piece of plastic or metal.

While earpiece 16 is shown with cups 20, the shape of the strap and other aspects of the invention can be used with other types of earpieces. For example, the earpiece can comprise an earmuff style where the earpiece covers the entire outside ears of the operator and includes a foam pad that rests against the sides of the operator's head. Alternatively, a disc style earpiece can be used that may include a form pad that rests directly against the outside of the operator's ear without inserting directly into the ear. Other types of ear plugs or ear plunger style earpieces can also be used that insert directly into the ear canal of the operator.

In one embodiment of the headset 14, a transducer 21 operates as a microphone and is located either in one of the ear cups 20 or in the main body section 23 of earpiece 16. The transducer 21 is used to detect sound waves and bone conduction that is emitted through the ear canal 28 when the operator 12 is talking. The transducer 21 converts the sound waves into electrical transmit signals that are output through a wire 25 that extends inside of the band 24. Another transducer 22 operates as a speaker and is located either in another one of the cups 20 or in the main body 23 for another one of the earpieces 16. The transducer 22 converts electrical receive signals from wires 25 into sound waves that are output into an opposite ear canal 30 of the operator 12.

The side view of the loopdown headset 14 in FIG. 2 shows how the ends 15 of band 24 extend in a slightly forward direction 32 toward the front face of operator 12. The middle potion of the band 24 then loops in a downward direction 34 underneath the chin 26 of operator 12. The ends 15 of the band 24 curve forward to extend in front of the earlobes 36 of the operator 12. This forward bend and downward loop in the band 25 in combination with the position of the cups 20 provide superior fit and comfort of the earpieces 16 in the ears of the operator 12. The forward curving ends 15 also prevent the band 24 from rubbing against earrings that the operator may be wearing.

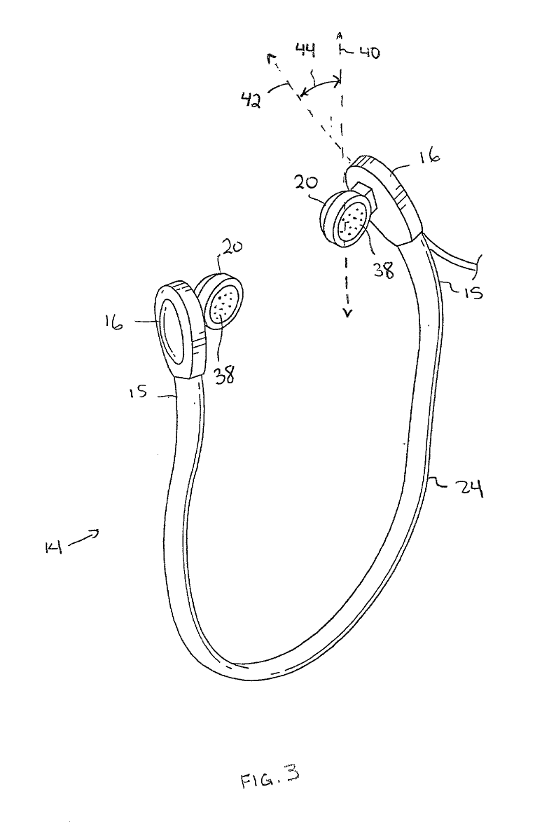

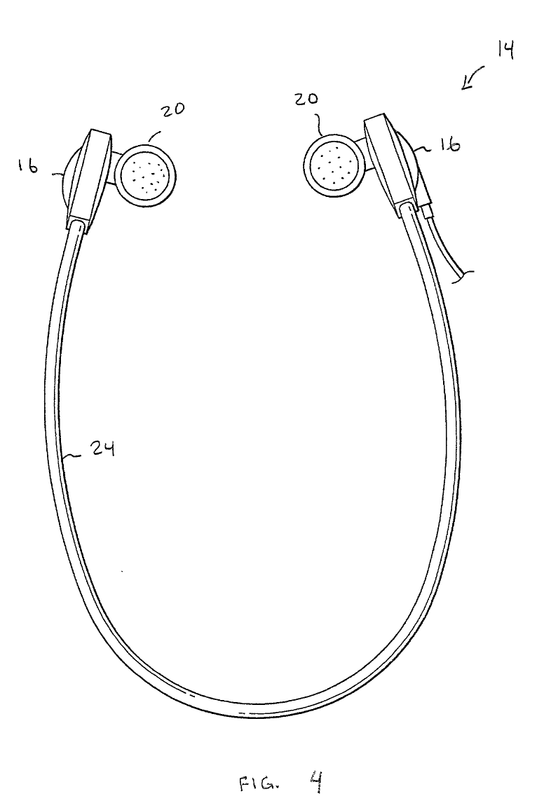

FIGS. 3 and 4 show in further detail the position of cups 20 in relationship to the forward and then downward direction of band 24. The cups 20 each have a front face 38 that extends substantially along a vertical plane 40. The opposite ends of the band extend longitudinally along a line 42 at an angle anywhere between 5 degrees to 45 from the vertical plane 42.

Referring to FIGS. 1-4, the headset 14 is pulled slightly outward at opposite ends 15 by the operator. The head of the operator is then slid between the opposite ends 15. The elastically deformable band 24 then retracks toward its original position as the earpieces 16 are inserted into ears of the operator. In the attached position, the opposite ends 15 extend forward and then downward from the ears of the user.

The transducer microphone 21 detects sound waves and bone conduction coming from the first ear canal 28 while the operator 12 is speaking. Because, the ear cup 20 is located inside the ear canal 28, there is little or no pickup of ambient noise. The speaker transducer 22 converts electrical receive signals into sound waves that are output into the second ear canal 30 of the operator 12.

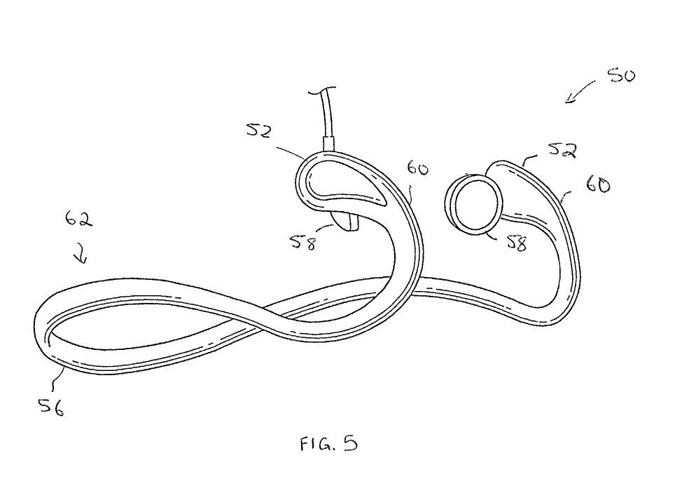

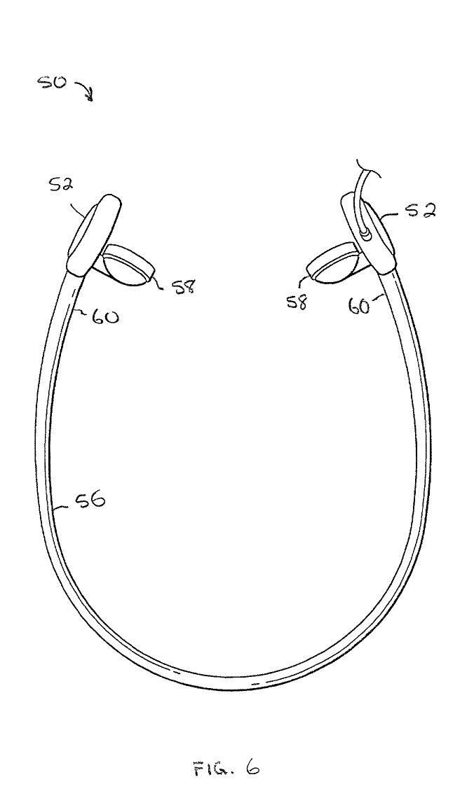

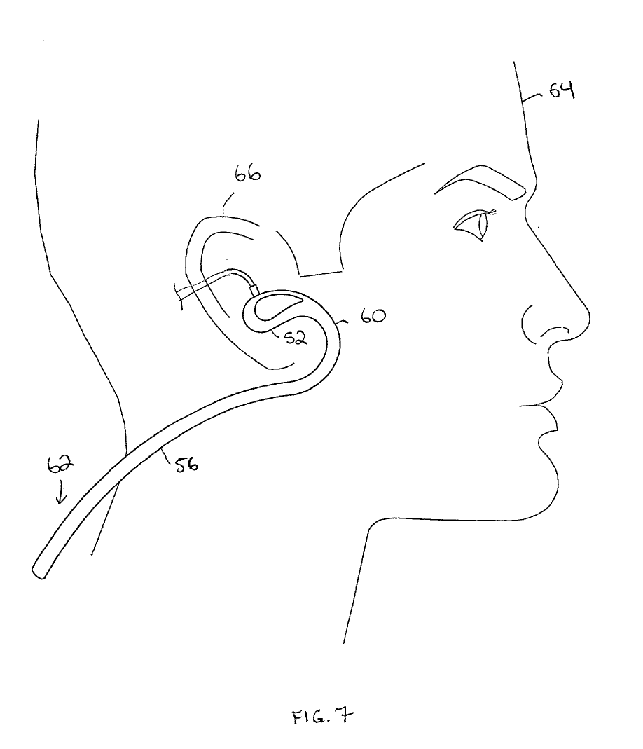

FIG. 5 shows a perspective view, FIG. 6 shows a top view, and FIG. 7 shows a side view for another embodiment of the invention. A headset 50 includes earpieces 52 and a band 56. The earpieces 52 include cups 58 similar to the cups 20 shown in FIG. 1. The opposite ends 60 of the band 56 extend from the earpieces 52 in a forward direction and then loop underneath ears 66 of the operator.

A middle portion 62 of the band 56 then extends back around a backside of the neck of the operator 64. This provides the additional advantage of obscuring the middle portion 62. For example, long hair or a shirt or coat may hide a portion of the band 56. This provides a more aestetically appealing look for the operator 64. In addition, the band 56 remains out of reach of others. For example, if operator 64 was holding a child, the child could not reach up and grab the band 56 since it is positioned behind the neck.

Again the forward and then downward direction of opposite ends 60 of the band provide superior comfort and retention of the cups 58 inside the operators ears. In addition, because the ends 60 loop underneath the ear 66, the band 56 will not rub up against earrings or other article that may be attached to the ears 66 of the operator 64.

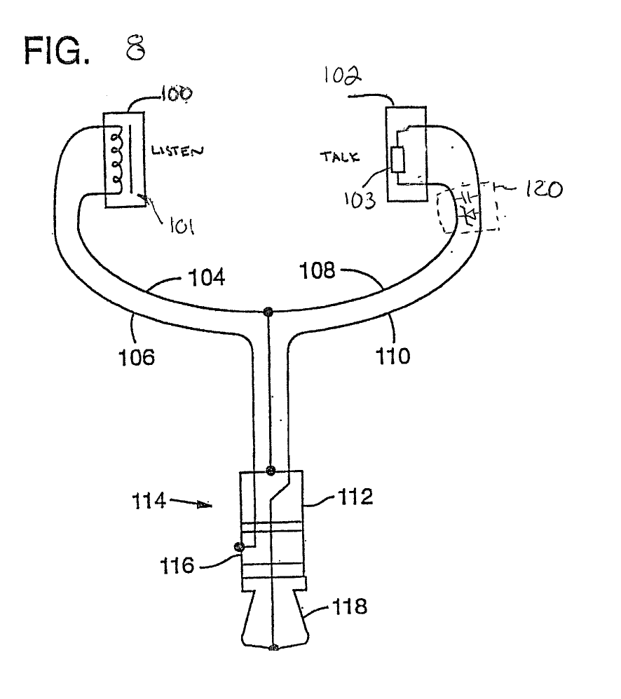

FIG. 8 is a schematic diagram showing one embodiment of the full duplex circuitry that can be located in either the headset 14 shown in FIG. 1 or the headset 50 shown in FIG. 5. The circuitry includes a speaker circuit 100 and a microphone circuit 102. Each circuit has two electrical terminals, with one serving as the common or “ground” node. A pair of wires 104, 106 and 108, 110 are connected to these terminals, and are ultimately joined in a single cord terminating in a connector plug 114. The wires connected to the ground node 104, 108 are joined together and terminate at the sleeve connection 112 of plug 114. The wire connected to the opposite terminal of the speaker circuit 100 is connected to a ring portion 116 of the plug 114. On the other side of the headset, the wire 110 from the microphone circuit 102 is connected to the tip portion 118 of the plug 114.

The speaker circuit 100 contains a transducer 101 that converts an electrical signal into an audio output. The microphone circuit 102 contains a transducer 103 that converts an audio input into an electrical signal which is communicated to a telephony device via the wires 108, 110.

By placing the microphone circuit 102 in or in close promity to the operator's ear canal, the transducer 103 can detect voice signals and bone conduction that start from the users vocal cords and pass through the operators head and out an external ear canal. Since the microphone circuit 102 is located inside or close to the ear canal, ambient noise is filtered from the transducer.

A filter circuit 120 includes a capacitor and an zenor diode that are coupled in parallel across the wires 108 and 110. The capacitor in one implementation is approximately 33 picofarads. The filter circuit 120 filters out selected frequency noise from the electrical transmit signal output by the microphone circuit 102.

The circuitry described above can use dedicated processor systems, micro controllers, programmable logic devices, or microprocessors that perform some or all of the mail notification operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

1. A headset, comprising:
earpieces for positioning in or next to ears of an operator; and
a band extending downwards from the two earpieces.

2. A headset according to claim 1 wherein opposite ends of the band extend forward from the earpieces and then a middle section of the band extends downwardly in a U shaped from the opposite ends.

3. A headset according to claim 1 wherein opposite ends of the band curve forward to extend in front of earlobes on the operator.

4. A headset according to claim 1 wherein a middle section of the band extends around a back side of the operator's neck.

5. A headset according to claim 1 wherein opposite ends of the band loop underneath ears of the operator.

6. A headset according to claim 1 wherein the band is made of a semi-rigid plastic.

7. A headset according to claim 1 wherein the earpieces comprise cups that extend perpendicularly inward from a longitudinal axis of the band.

8. A headset according to claim 7 wherein the cups each have a front face that extends along a vertical plane and opposite ends of the band extend along a longitudinal axis at an angle between 5 degrees and 45 from the vertical axis of the cups.

9. A headset according to claim 1 wherein a first one of the earpieces contains a speaker circuit for converting an electrical receive signal into sound waves and a second one of the earpieces contains a microphone circuit that converts sound waves or bone conduction coming from an ear canal of the operator into an electronic transmit signal.

10. A headset according to claim 9 including a filter circuit coupled across the microphone circuit.

11. A headset according to claim 10 wherein the filter circuit includes a diode and a capacitor.

12. A method for using a headset, comprising:
inserting earpieces of the headset into ears of a user;
positioning a band coupled to the earpieces to extend forward from the earpieces;
inserting into a first one of the earpieces a microphone for detecting bone conduction or sound waves coming from a first ear canal of the user when the user is speaking; and
converting the detected sound waves into electrical transmit signals.

13. A method according to claim 12 including inserting into a second one of the earpieces a speaker for converting electrical receive signals into sound waves for outputting into a second ear canal of the user.

14. A method according to claim 12 including positioning a middle portion of the band to extend downward below a chin of the user.

15. A method according to claim 12 including positioning a middle portion of the band to extend backwards in a loop.

16. A method according to claim 12 including positioning the earpieces in relationship to opposite ends of the band so that the band extends in a forward direction and then downward when the earpieces are inserted in the users ears.

17. A headset, comprising:
a first earpiece that contains a microphone for converting sound waves emitted from a first ear canal into electrical transmit signals;
a second earpiece that contains a speaker for converting electrical receive signals into audible sound waves for outputting into a second ear canal; and
a band that includes opposite ends that extend forward from the two earpieces.

18. A headset according to claim 17 including a middle portion of the band that extends downward from the opposite ends.

19. A headset according to claim 18 including cups extending from the two earpieces that insert into the ear canals, the cups each having a flat front face and a curved backside.

20. A headset according to claim 19 wherein the front faces of the cups sit in a substantially vertical axis inside the ear canals and the opposite ends of the band extend from the earpieces in a forward and downwardly sloping angle from the vertical axis.
